(19) United States
(12) Patent Application Publication
(10) Pub. No.: US 2006/0292897 A1
(43) Pub. Date: Dec. 28, 2006

(54) Board, connector, connector detaching device and method of detaching connector

(75) Inventors: Yoko Murata, Kawasaki (JP); Setuo Kojima, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/231,740

(22) Filed: Sep. 22, 2005

(30) Foreign Application Priority Data
Jun. 27, 2005 (JP) 2005-186101

(51) Int. Cl. H01R 12/00

(52) U.S. Cl. 439/64

(57) ABSTRACT

A connector detaching device detaches a connector that has a terminal projecting from a frame thereof and is attached to a board by insertion of the terminal into the board. The connector is attached to the board having a through hole filled by the frame of the connector attached to the board. The device includes: a board supporting jig that has a base and plural supporting arms extending from the base in an arrayed manner and supports the board with the plural supporting arms from a surface of the board to which the connector is attached by straddling the connector; and a push-out jig that has an insertion rod having a diameter smaller than the through hole and pushes the frame of the connector by the insertion rod through the through hole from a side reverse to the side of the surface to which the connector is attached.

### BACKGROUND OF THE INVENTION

1. Field of the Invention

The present invention relates to a board to which a connector is attached, a connector which is attached to a board, and a connector detaching device which detaches a connector attached to a board, and a method of detaching a connector.

2. Description of the Related Art

A connector which is attached to a printed circuit board which is built in a server, a communication device, etc. and connects the printed circuit board and an electric circuit together, has hitherto been widely used. Usually, a connector is provided with multiple terminals which are connected to each of the multiple electric lines extending from an electric circuit, these multiple terminals are each inserted into multiple through holes provided in a printed circuit board, the terminals are further fixed, by soldering, for example, whereby the printed circuit board and the electric circuit are electrically connected together via the connector.

Incidentally, usually, it is not expected that when a connector is once attached to a printed circuit board, the attached connector might be detached and, therefore, by press fitting the terminals of the connector into the through holes of the printed circuit board, the connector is firmly fixed to the printed circuit board, whereby efficient and positive energization is achieved between the printed circuit board and the electric circuit. However, when failures occur in part of the inner components of a server, a communication device, etc. and inspection, replacement and the like of the components are performed, it becomes necessary to extract the connector from the printed circuit board.

Because as described above, a connector provided with many terminals is firmly fixed to a thin printed circuit board, there is a possibility that when the connector is to be taken out with hand, the through holes might be forced open, resulting in the breakage of the board, and that the terminals might be broken and remain within the board. Although it is conceivable to disassemble a connector and to take out the terminals one by one in order to avoid the breakage of a board, this takes much trouble and time. Such difficulty in detaching a connector prevents the reuse of printed circuit boards and connectors.

Methods of detaching a connector by use of a jig have been known in addition to methods of detaching a connector with hand as described above.

FIG. 1 is a diagram to explain how to detach a connector from a board by use of a jig.

Part (A) of FIG. 1 shows a board 10 provided with multiple through holes (not illustrated), a connector 20 attached to the board 10, and a jig 30 which pulls the connector 20. As shown in part (A) of FIG. 1, the connector 20 is constituted by a housing 21 which is provided with a gripping area 21a to be gripped by the jig 30 and multiple terminals 22 which project from the housing 21, and this connector 20 is attached to the board 10 when the multiple terminals 22 are each inserted into the multiple through holes made in the board 10. By withdrawing the jig 30 which grips the gripping area 21a of the connector 20 in the direction of the arrow A, it is possible to detach the connector 20 from the board 10 without damaging the terminals 22 etc.

Part (B) of FIG. 1 shows a board 10, a connector 20 and a jig 40 which depresses the connector 20 from the terminal 22 side. In the connector shown in part (B) of FIG. 1, the gripping area 21a shown in part (A) of FIG. 1 is not provided. However, the terminals 22 are supported by a small housing 21 and the terminals 22 are inserted into the through holes of the board 10, pierce through the through holes and project. The jig 40 depresses the terminal 22 side projecting from the board 10 and, therefore, it is possible to detach the connector 20 from the board 10 although the housing 21 is not provided with the gripping area 21a.

However, in the method shown in part (A) of FIG. 1, it is necessary that the housing 21 of the connector 20 have the gripping area 21a having a width and strength large enough for catching the jig 30 above the portion from which the terminals 22 project, thereby posing the problem that the thickness and width of the connector 20 increase considerably. In the method shown in part (B) of FIG. 1, there is a possibility that the terminals 22 buckles or the board 10 warps when the jig 40 depresses the connector 20, with the result that the connector 20 could not be detached from the board 10.

In addition to the above-described methods, there have been proposed a technique which uses a shapememory alloy, which is less apt to be deformed and can be restored to an original state by heat even when deformed, and suppresses the deformation of the terminals during the detachment of the connector from the board (refer to the Japanese Patent Laid-Open No. 9-199821), a technique which gives elasticity to a portion of contact between the board and the connector and reduces the breakage of the connector terminals (refer to the Japanese Patent Laid-Open No. 8-88038), etc. By using these techniques described in the Japanese Patent Laid-Open No. 9-199821 and the Japanese Patent Laid-Open No. 8-88038 in combination with the above-described connector detaching methods which use a jig, it is possible to detach the connector 20 from the board 10 without breaking the connector 20 and the board 10 and to reuse the connector 20 and the board 10.

However, in the method shown in the Japanese Patent Laid-Open No. 9-199821, the terminals of a connector are fabricated from an expensive shapememory alloy, thereby posing the problem that the cost of the whole device rises. In the method shown in the Japanese Patent Laid-Open No. 8-88038, it is necessary that the minute portion where the connector and the board are in contact with each other be subjected to special working, thereby posing the problem that the manufacturing of the connector and the board becomes complicated.

### SUMMARY OF THE INVENTION

The present invention has been made in view of the above circumstances and provides a board, a connector, a connector detaching device and a method of detaching connector, which can detach the connector by a simple mechanism without the breakage of the connector and the board.

The present invention provides a board to which a connector having a terminal projecting from a frame thereof is attached by insertion of the terminal, including:

a terminal insertion section into which the terminal is inserted; and

a through section having a through hole which pierces through both sides of the board and which is filled by the frame by the insertion of the terminal into the terminal insertion section.

With the board of the present invention, in addition to the terminal insertion section into which the terminal of the connector is inserted, there is made a through hole which is filled by the frame of the connector, and by pushing the frame of the connector from this through hole, it is possible to detach the connector without the breakage of the terminal of the connector.

In the present invention, there is provided a connector which is connected to a board, which includes:

a frame;

a terminal which projects from one surface of the frame and is inserted into the board; and

a high-strength section which is provided within the one surface of the frame and can withstand the abutting by a force necessary for the extraction of the terminal from the board.

With the connector of the present invention, a high-strength section is provided within on the same surface as the surface on which the terminal is provided. Therefore, a through hole is made in the board and by the depression of the high-strength section from the through hole, this connector can be easily detached from the board.

It is preferred that the connector of the present invention further have a through section having a through hole which pierces through the frame from a position within the one surface nearer to the center relative to the position of the high-strength section to an opposite side of the frame.

In a case where a wide connector has been attached to a thin board and the like, even when a through hole is provided in the board and the connector is depressed via the through hole, there is a possibility that the board might warp, with the board adhering to the connector, making it impossible to detach the connector. By the arrangement in which a through hole is provided in the connector and the board is supported from a direction reverse to a force with which the connector is depressed, a warp of the board is suppressed and the connector can be positively detached.

The present invention provides a connector detaching device which detaches a connector having a terminal projecting from a frame thereof, which has been attached to a board by insertion of the terminal into the board, wherein:

the connector detaching device detaches the connector attached to the board having a through hole which is filled by the frame of the connector attached to the board, and

the connector detaching device includes:

a board supporting jig which is provided with a base and a plurality of supporting arms extending from the base in an arrayed manner and supports the board with the plurality of supporting arms from a surface of the board to which the connector is attached by straddling the connector; and

a push-out jig which is provided with an insertion rod, which has a diameter smaller than the through hole, and pushes the frame of the connector by use of the insertion rod through the through hole from a side reverse to the side of the surface to which the connector is attached.

With the connector detaching device of the present invention, the insertion rod pushes the frame of the connector via the through hole of the board and, therefore, the connector can be detached from the board without the breakage of the terminal of the connector.

It is preferred that there be made a through hole which pierces in a direction toward the substrate and that the board supporting jig be provided with an abutting rod which extends from the base and supports the board by being inserted into the through hole of the connector.

With a connector detaching device in a preferred embodiment of the present invention, the board is supported by the insertion rod in a direction reverse to the direction in which the insertion rod pushes the connector and, therefore, a warp of the board is reduced and the connector can be efficiently detached.

The present invention provides a connector detaching method which detaches a connector attached to a board by insertion of a terminal into the board and which has the terminal projecting from a frame thereof, wherein:

the board has a through hole which is filled by the frame of the connector attached to the board, and

the method includes the steps of:

supporting the board by use of a board supporting jig which is provided with a base and a plurality of supporting arms extending from the base in an arrayed manner and supporting the board with the plurality of arms from a surface of the board to which the connector is attached by straddling the connector;

inserting the insertion rod, which is smaller in diameter than the through hole, into the through hole from a side reverse to the side of the surface of the board to which the connector is attached; and

detaching the terminal from the board by pushing the frame of the connector by use of the insertion rod of the push-out jig.

According to the present invention, the connector is detached from the board by a simple mechanism without the breakage of the board and the connector.

### BRIEF DESCRIPTION OF THE DRAWINGS

FIG. 1 is a diagram to explain how to detach a connector from a board by use of a jig;

FIG. 2 is a diagram to show a connector in a first embodiment of the present invention;

FIG. 3 is a top plan view of a board in the first embodiment of the present invention;

FIG. 4 is a sectional view of a board 200 and a connector 100 when the connector 100 is attached to the board 200;

FIG. 5 is a diagram to show a connector detaching device in the first embodiment of the present invention;

FIG. 6 is a diagram to show a connector in a second embodiment of the present invention; and

FIG. 7 is a diagram to show a connector detaching device in the second embodiment of the present invention.

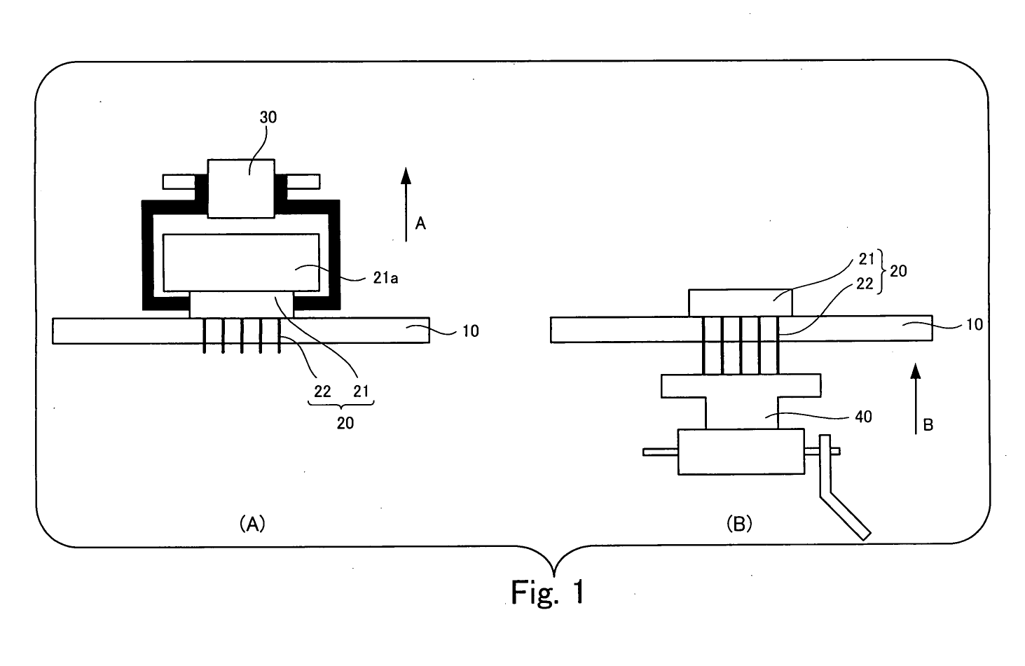

### DETAILED DESCRIPTION OF THE INVENTION

Embodiments of the present invention will be described.

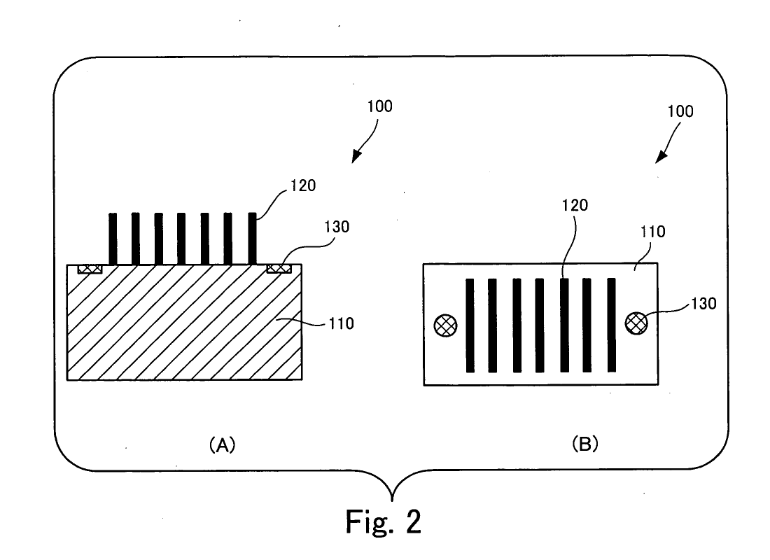

FIG. 2 is a diagram to show a connector in a first embodiment of the present invention.

Part (A) of FIG. 2 shows a side view of a connector 100, and part (B) of FIG. 2 shows a view of the connector 100 shown in part (A) of FIG. 2 as viewed from above.

As shown in part (A) of FIG. 2, the connector 100 is constituted by a housing 110 and multiple terminals 120 held by the housing 110, and these multiple terminals 120 project from one surface of the housing 110. As shown in part (B) of FIG. 2, a reinforcing portion 130 having high strength is provided within the surface of the housing 110 from which the terminals 120 project. The housing 110 corresponds to an example of the “frame” in the connector of the present invention, the terminals 120 correspond to an example of the “terminal” in the connector of the present invention, and the reinforcing portion 130 corresponds to an example of the “high-strength section” in the connector of the present invention.

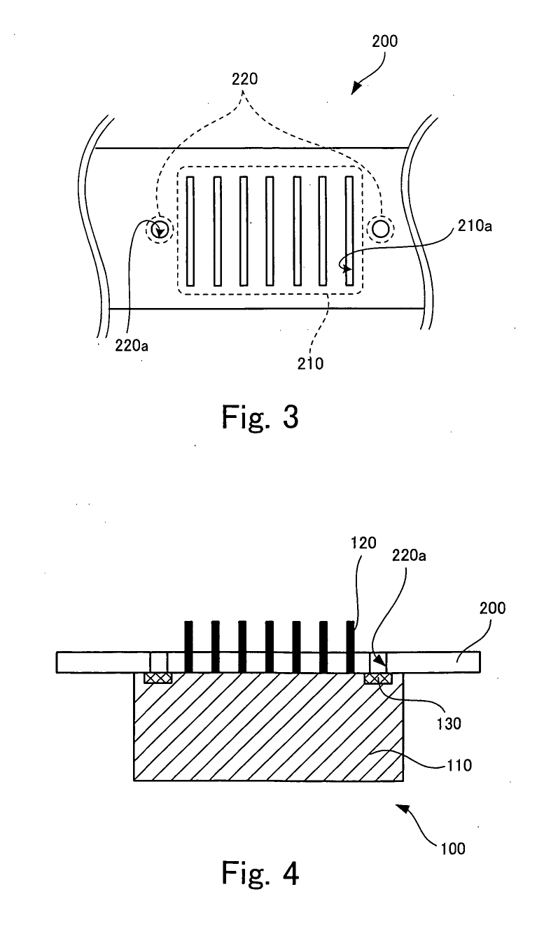

FIG. 3 is a view of a board in the first embodiment of the present invention.

A board 200 has the shape of a thin plate, and multiple insertion holes 210a are made in the board 200. The multiple insertion holes 210a pierce through both surfaces of the plate and each of the multiple terminals 120 shown in FIG. 2 is inserted into the insertion holes 210a. In the board 200, a through hole 220a is made in a portion which is opposed to the reinforcing portion 130 of the connector 100 when the terminal 120 is inserted into insertion hole 210a. The portion 220 where the insertion hole 210a is provided corresponds to an example of the “terminal insertion section” in the board of the present invention, and the portion 210 where the through hole 220a is made corresponds to an example of the “through section” in the board of the present invention.

Each of the multiple terminals 120 provided in the connector 100 shown in FIG. 2 is inserted into each of the multiple insertion holes 210a made in the board 200 shown in FIG. 3 and the connector 100 is press fitted into the board 200, whereby the connector 100 is attached to the board 200.

FIG. 4 is a sectional view of the board 200 and the connector 100 when the connector 100 is attached to the board 200. Incidentally, because the insertion hole 210a shown in FIG. 3 is made to adapt to the size of the terminal 120, the terminal 120 is fitted into the insertion hole without a clearance. For this reason, hereinafter, in figures which show the condition in which the terminal is inserted into the insertion hole, there is no special distinction between the terminal and the insertion hole.

As shown in FIG. 4, when the connector 100 is attached to the board 200, the terminal 120 projects from the back surface of the surface of the board 200 to which the connector 100 is attached (hereinafter, the surface to which the connector 100 is attached is called the attaching surface), and the through hole 220a made in the board 200 is filled by the reinforcing portion 130 of the connector 110.

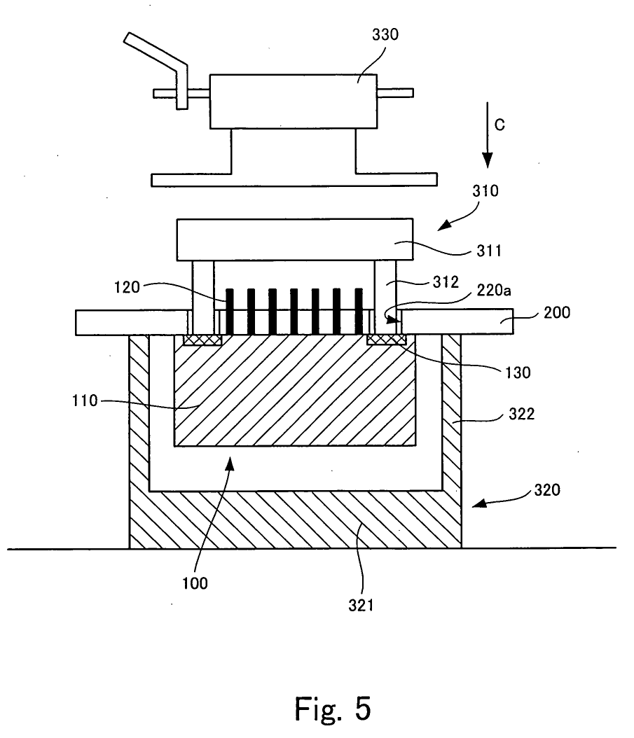

FIG. 5 is a diagram to show a connector detaching device in the first embodiment of the present invention.

The connector detaching device is constituted by a push-out jig 310, a board supporting bed 320 and a depressing jig 330.

The board supporting bed 320 is constituted by a base 321 and multiple supporting rods 322 which extend vertically upward from the base 321, and the push-out jig 310 is provided with a depressing plate 311 and insertion rods 312 which are smaller in diameter than the through holes 220a of the board 200. The base 321 corresponds to an example of the “base” in the connector detaching device of the present invention, the multiple supporting rods 322 correspond to an example of the “plurality of supporting arms” in the connector detaching device of the present invention, the board supporting bed 320 corresponds to an example of the “plate supporting jig” in the connector detaching device of the present invention. The insertion rod 312 corresponds to an example of the “insertion rod” in the connector detaching device of the present invention, and the push-out jig 310 corresponds to an example of the “push-out jig” in the connector detaching device of the present invention.

Hereinafter, a series of procedures for detaching the connector 100 from the board 200 by using this connector detaching device will be described.

First, the board 200 is placed on the board supporting bed 320 in such a manner that with the attaching surface (the surface to which the connector 100 is attached) facing downward, the connector 100 is positioned between the multiple supporting rods 322. As a result, the multiple supporting rods 322 of the board supporting bed 320 support the board 200 from the attaching surface side by straddling the connector 100. This step of supporting the board 200 with the board supporting bed 320 corresponds to an example of the step of “supporting the board by use of a board supporting jig” in the connector detaching method of the present invention.

Subsequently, the insertion rod 312 of the push-out jig 310 is inserted into the through hole 220a of the board 200. As a result, the board supporting bed 320 supports the board 200 from the attaching surface side and, at the same time, the insertion rod 312 is inserted into the through hole 220a from the backside of the attaching surface of the board 200 and brought into contact with the reinforcing portion 130 of the connector 100. This step of inserting the insertion rod 312 into the through hole 220a corresponds to the step of “inserting the insertion rod” in the connector detaching method of the present invention.

When the insertion rod 312 is inserted, the depressing plate 311 is depressed by the depressing jig 330 in the direction of the arrow C. The connector 100 is pushed down by the insertion rod 312 and the terminal 120 is extracted from the insertion hole 210a and detached from the board 200. This step of detaching the connector 100 from the board 200 by use of the insertion rod 312 corresponds to an example of the step of “detaching the terminal from the board” in the connector detaching method of the present invention.

The reinforcing portion 130 which comes into contact with the insertion rod 312 has high strength and can withstand the abutting force with which the reinforcing portion 130 is pushed by the insertion rod 312. Because the depressing jig 330 depresses the housing 110 which supports the terminal 120, and not the terminal 120 itself, with the connector detaching device of this embodiment, it is possible to easily detach the connector 100 from the board 200 by reducing the breakage of the terminal 120 and the like.

With the foregoing, the description of the first embodiment of the present invention is finished, and the second embodiment of the present invention will be described below. The first and second embodiments of the present invention have almost the same constitutional features, with the exception that the construction of the connector and the board supporting bed are partially different. Therefore, the same parts are identified by the same reference characters, their descriptions are omitted, and a description will be given only of points in which the first and second embodiments differ.

In a case where a connector having a large width is attached to a board which is thin and apt to warp, if the reinforcing portion of the connector is depressed by the insertion road in the same manner as in the first embodiment, there might sometimes occur a case where the board deflects and it is difficult to detach the connector from the board. In a connector detaching device of this embodiment, the deflection of the board is reduced by supporting the board from a surface opposite to the surface on which the depressing by the insertion rod is preformed.

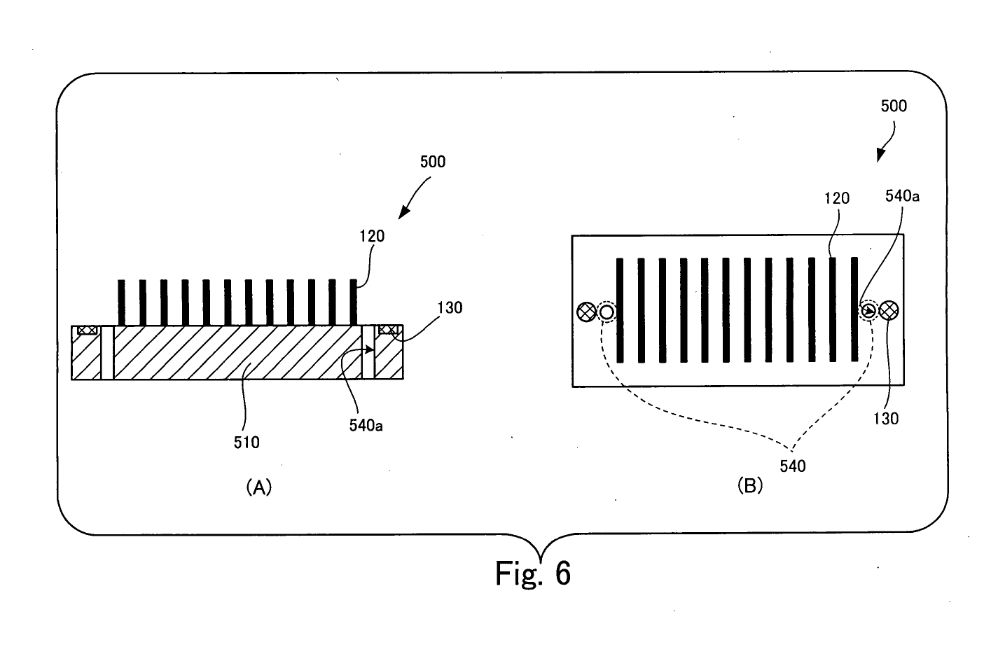

FIG. 6 is a diagram to show a connector in a second embodiment of the present invention.

As shown in part (A) of FIG. 6, in a connector 500 of this second embodiment, the number of terminals 120 is larger than in the connector 100 of the first embodiment shown in FIG. 2, and the transverse length in which the terminals 120 are arrayed increases accordingly. Also, as shown in part (B) of FIG. 6, in the connector 500 in a position inward from the position where a reinforcing portion 130 is provided, there is made a through hole 540a which pierces through a housing 510. When the connector 500 is attached to a board 200, a through hole 540a is filled by the board 200. The portion 540 where this through hole 540a is made corresponds to an example of the “through section” in a connector of the present invention.

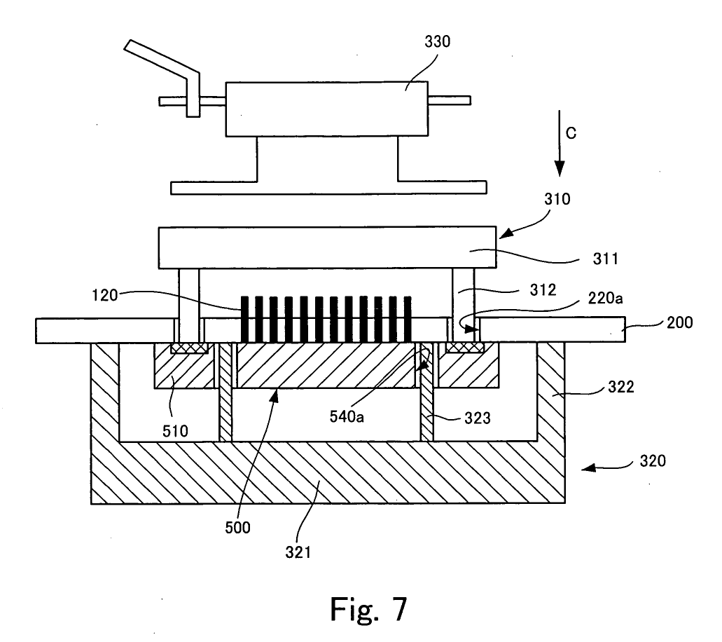

FIG. 7 is a diagram to show a connector detaching device in the second embodiment of the present invention.

Although the connector detaching device of this embodiment has almost the same construction as the connector detaching device of the first embodiment shown in FIG. 5, there is provided an abutting rod 323 which extends from a base 321 of a board supporting bed 320 and is inserted into the through hole 540a of the connector 500 which is attached to the board 200. This abutting rod 323 corresponds to an example of the “abutting rod” in the connector detaching device of the present invention.

When the board 200 to which the connector 500 has been attached is placed on the board supporting bed 320, with the attaching surface (the surface to which connector 500 is attached) facing downward, the multiple supporting rods 322 support the board 200 from the attaching surface side by straddling the connector 500 and, at the same time, the abutting rod 323 is inserted into the through hole 540a made in the connector 500 and is caused to abut against the attaching surface of the board 200.

Subsequently, an insertion rod 312 of a push-out jig 310 is inserted into an insertion hole 220a of the board 200 and a depressing plate 311 is depressed by a depressing jig 330 in the direction of the arrow C. Because at that time, the board 200 is supported by the abutting rod 323 in the direction reverse to the direction of the arrow C, the trouble that the board 200 deflects is alleviated. Thus, with the connector detaching device of the second embodiment, even in a case where a large connector is attached to a thin and wide board, the connector can be positively detached from the connector.

In the foregoing, the description has been given of an example of a connector in which terminals project from only one surface of the frame. However, a connector of the present invention may be such that terminals project also from a surface other than the one surface of the frame.

Also, in the foregoing, the description has been given of an example in which the high-strength section of the connector which is depressed by the connector detaching device is provided in two places at ends which interpose the position where the terminals are provided. However, the high-strength section in the connector of the present invention may be provided in a gap between the terminals or the like. In this case, it is possible to suppress an increase in connector size. Similarly, in the foregoing, the description has been given of an example in which the through section of the board into which the insertion rod of the connector detaching device is inserted is provided outward from the terminal insertion section into which the terminals of the connector are inserted. However, the through section and the terminal insertion section in the board of the present invention may be provided in a mixed manner. In this case, it is possible to suppress an increase in connector size.

The abutting rod of the present invention and the through hole of the connector of the present invention may be provided in a suitable position between the multiple terminals of the connector.

Also, in the foregoing, the description has been given of an example in which the depressing plate 311 is depressed by the depressing jig 330, whereby the insertion rod 312 is indirectly pushed. However, the insertion rod called as such in the present invention may also be pushed by human beings without the use of the depressing jig.

What is claimed is:

1. A board to which a connector having a terminal projecting from a frame thereof is attached by insertion of the terminal, comprising:
a terminal insertion section into which the terminal is inserted; and
a through section having a through hole which pierces through both sides of the board and which is filled by the frame by the insertion of the terminal into the terminal insertion section.

2. A connector which is connected to a board, comprising:
a frame;
a terminal which projects from one surface of the frame and is inserted into the board;
a high-strength section which is provided within the one surface of the frame and can withstand the abutting by a force necessary for the extraction of the terminal from the board.

3. The connector according to claim 2, wherein the connector further comprises a through section having a through hole which pierces through the frame from a position within the one surface nearer to the center relative to the position of the high-strength section to an opposite side of the frame.

4. A connector detaching device which detaches a connector having a terminal projecting from a frame thereof, which has been attached to a board by insertion of the terminal into the board, wherein:
the connector detaching device detaches the connector attached to the board having a through hole which is filled by the frame of the connector attached to the board, and
the connector detaching device comprises:
a board supporting jig which is provided with a base and a plurality of supporting arms extending from the base in an arrayed manner and supports the board with the plurality of supporting arms from a surface of the board to which the connector is attached by straddling the connector; and
a push-out jig which is provided with an insertion rod, which has a diameter smaller than the through hole, and pushes the frame of the connector by use of the insertion rod through the through hole from a side reverse to the side of the surface to which the connector is attached.

5. The connector detaching device according to claim 4, wherein in the connector there is made a through hole which pierces in a direction toward the substrate and the board supporting jig is provided with an abutting rod which extends from the base and supports the board by being inserted into the through hole of the connector.
